(19) United States
(12) Patent Application Publication
(10) Pub. No.: US 2014/0172445 A1
(43) Pub. Date: Jun. 19, 2014

(54) Bill Payment Risk Level Determination

(71) Applicant: Homan Hajbandeh, Scottsdale, AZ (US)

(72) Inventor: Homan Hajbandeh, Scottsdale, AZ (US)

(21) Appl. No.: 14/106,679

(22) Filed: Dec. 13, 2013

Related U.S. Application Data
(60) Provisional application No. 61/736,821, filed on Dec. 13, 2012.

(51) Int. Cl. G06Q 50/22; G06Q 20/40

(52) U.S. Cl. CPC G06Q 50/22; G06Q 20/4016
USPC 705/2

(57) ABSTRACT

Transaction histories of payers responsible for paying past due bills of respective patients are centrally logged and reported among a plurality of healthcare providers. The healthcare providers use the transaction history and/or respective risk level of a particular payer to screen a corresponding patient prior to providing the patient healthcare service.

### FIELD

Embodiments generally relate to articles of manufacturer, apparatuses, devices, methods, and systems for evaluating a risk level associated with a payer, and more particularly, to a risk level associated with a payer paying an unidentified, actual, estimated, or potential bill for a healthcare service.

### BACKGROUND

One of the main challenges of healthcare providers (e.g., doctors, physicians, physician assistants, nurses, chiropractors, alternative medicine consultants, psychologists, podiatrists, hospitals, clinics, urgent care units, ambulatory outpatient surgery centers, sleep labs, radiology chains, diagnostic laboratories, dieticians . . . etc.), is collection on outstanding bills that have not been paid by payers responsible for a bill (e.g., patients, parents of patients, insurers, and the like). Recent statistics have shown that patient bad debt has resulted in about US$65 billion in uncollected revenues in 2010. According to a Medical Group Management Association survey of physicians for 2010, bad debt per physicians ranged from an annual average of US$12,679 for primary care physicians to US$29,393 for surgical specialties. A 2010 McKinsey report found that for insured patients, at one multi-facility hospital system, “balance after insurance” bills is growing at 30% per year and a 2010 Commonwealth Fund study indicated that 53 million people reported problems paying their medical bills, up from 39 million in 2005. Collection agencies contacted 30 million people about their medical debts, up from 22 million in 2005. Moreover, the Agency for Healthcare Research and Quality (AHRQ), a department of the U.S. Department of Health and Human Services, released an annual Medical Expenditure Panel Survey showed the number of private sector employees that have deductibles, the amount of the deductible, and the amount of the primary care provider co-pays as all increasing every year.

Typically, healthcare providers bill a payer subsequent to admitting a patient and providing a respective healthcare services. Consequently, the healthcare provider's resources are spent and lost when the payer reneges his responsibility to pay all or some of the corresponding bill. Healthcare providers, in turn, try to collect on the patient's balance according to each healthcare office's own policies, such as by sending about 3 reminder bills to the payer. After the healthcare provider fails to collect the balance, the healthcare provider discharges the patient and sends the bill to a collection agency. The collection agencies typically charge about 25-35% of what is collected. The expected rate of collection at this point is less than about 50%. When the bill is no longer considered collectable, the physician is forced to write off the bad debt. The physician has now lost revenue, time, energy, a patient, and money attempting to collect the balance owed and then the bad debt.

Such nonpayment of healthcare bills affect a payer's general credit score at a credit bureau (e.g., Fair Isaac Corporation) only if the healthcare provider turns over the unpaid bill to a collection agency. Consequently, unpaid healthcare bills do not affect the payer's general credit score if the corresponding healthcare provider does not report them to a collection agency, even if the unpaid healthcare bill is gravely overdue.

Moreover, credit bureaus do not differentiate between nonpayment of healthcare bills and other bills (e.g., car payments) because a report from the credit bureau only shows a collection action, not the cause for the action.

Accordingly, it would be an advance in the art of healthcare service to provide solutions that can determine a risk level associated with a payer of a healthcare service.

### SUMMARY

In certain embodiments, an article of manufacture includes a computer readable program code that includes steps to receive data about a past transaction of a payer towards payment of a corresponding past bill. The computer readable program code further includes steps to use a predetermined rule and the received data to determine a risk level associated with the payer paying a future bill of a healthcare provider.

In certain embodiments, a computer program product includes computer readable program code that causes a programmable processor to receive data about a past transaction of a payer towards payment of a past bill for a first healthcare service rendered to a first patient by a first healthcare provider. The computer program product further includes computer readable program code that causes a programmable processor to use a predetermined rule and the received data to determine a risk level associated with the payer paying a future bill.

In certain embodiments, a method for patient admittance includes forming, at a computing device, a transmission including a request to receive information regarding a risk level of a payer paying a future bill associated with a first healthcare service, wherein the risk level is based on a transaction history of the payer towards payment of a plurality of past bills associated with corresponding second healthcare services. The method further includes receiving the information and using the received information and a predetermined admittance standard to determine if the first patient is to be admitted to receive the first healthcare service.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates a system for analyzing a transaction history of a payer;

FIG. 2 is a flow chart illustrating a method for analyzing a transaction history of a payer within the system of FIG. 1;

FIG. 3 is a flow chart illustrating a method for determining whether to admit a patient using the system of FIG. 1;

FIG. 4 includes a screen shot of a user interface associated with a Provider Computing Device for providing data about a payer within the system of FIG. 1;

FIGS. 5a-5b each includes a screen shot of a user interface associated with a User Computing Device for determining whether to admit a patient using the system of FIG. 1; and

FIGS. 6-9 are each a flow chart illustrating a corresponding method for analyzing a transaction history of a payer within the system of FIG. 1.

### DETAILED DESCRIPTION

Healthcare providers, their agents, and/or collection agencies (collectively, “health transaction history providers”); and/or credit bureaus electronically provide, to a host, data associated with a transaction history (payment and/or nonpayment) of a payer that is responsible for paying past due bills (e.g., statements and/or invoices). The host compiles the received information and determines a risk level associated with the payer paying a future bill. In certain embodiments, the future bill is an unidentified bill (e.g., a bill not associated with the healthcare services to be rendered to the patient, such as randomly selecting “$1000” as the future bill); in other embodiments, the future bill is an identified bill such as an actual, estimated, or potential bill of a healthcare provider for rendering healthcare services to the patient. The host provides the healthcare provider an indicium of the risk level, such as a log of overdue bills, compiled transaction information regarding relevant overdue bills, a score, a rating, and/or a description, and the like. The healthcare provider, in turn, uses the received indicium of risk level to screen the patients prior to admission. Moreover, payers and patients that default on their outstanding or overdue past bills for healthcare service (the “healthcare service” includes healthcare services, such as diagnosis, as well as healthcare products, such as medication) will have a more difficult time obtaining subsequent appointments with the same or different healthcare providers, which creates an incentive for the payer to pay such overdue bills. In certain embodiments, full or partial payment of overdue past bills is further reported to the host and the corresponding risk level associated with the payer is updated, potentially improving a corresponding score of the payer. Similarly, in certain embodiments, payers have an incentive to timely pay bills for healthcare services because, at least in part, the turn around rate, payment, or nonpayment of healthcare bills is centrally logged and reported among a plurality of healthcare providers.

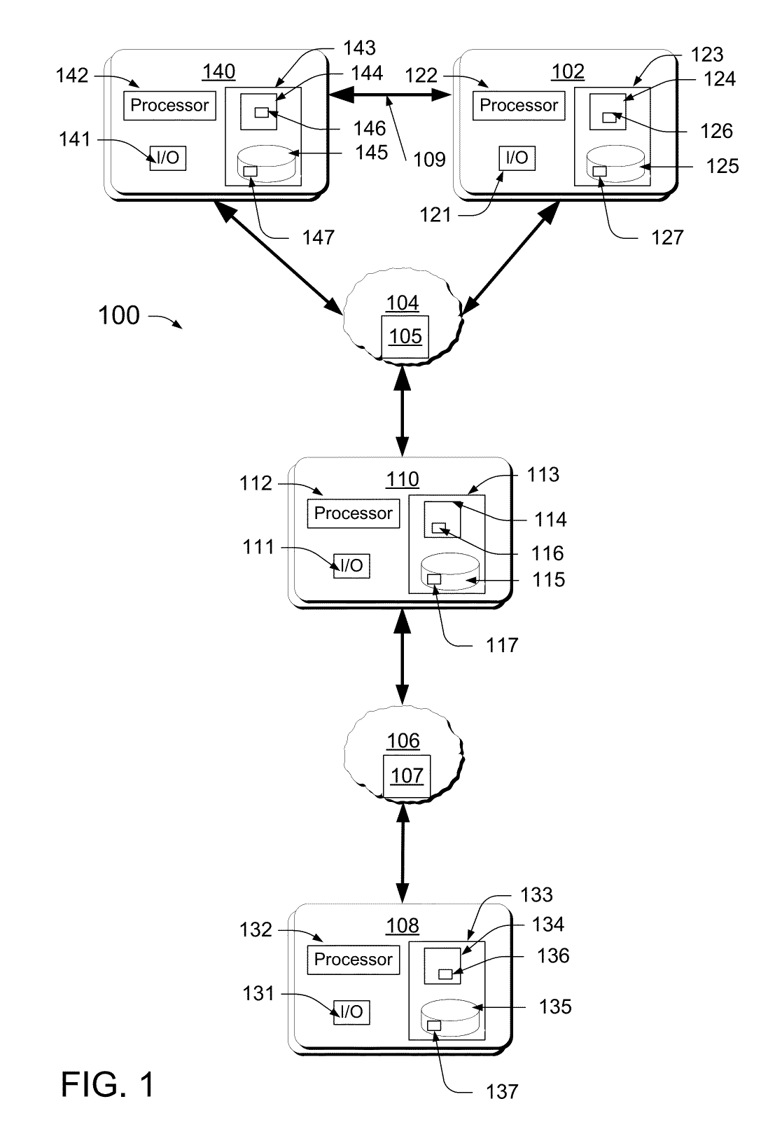

FIG. 1 illustrates a system 100 for analyzing a transaction history of a payer. In the illustrated embodiment of FIG. 1, system 100 comprises a computing device 110 that is communicatively connected to at least one of a computing device 102 and a computing device 140 through a first communication fabric 104; and a computing device 108 through a second communication fabric 106. In other embodiments, the computing device 110 is communicatively connected to the computing device 102 through a first communication fabric 104 and to the computing device 140 through a third communication fabric not shown.

In certain embodiments, the computing device 110 is a computing device that is owned and/or operated by a host (also “Host Computing Device 110”); the computing device 102 is a computing device that is owned and/or operated by a health transaction history provider (“History Provider Computing Device 102”); the computing device 140 is a computing device that is owned and/or operated by a credit bureau (“Bureau Computing Device 140”); and/or the computing device 108 is a computing device that is owned and/or operated by a user such as a patient or a healthcare provider (“User Computing Device 108”). In certain embodiments, the User Computing Device 108 includes an Electronic Medical Record system of the User that is a healthcare provider.

A health transaction history provider provides data about one or more payers' (persons' or entities' responsible for paying money for something) past transactions (e.g., payment or non-payment) of one or more healthcare bills/statements/invoices, for example. Examples of health transaction history providers include: a payer that has taken on the responsibility of paying a healthcare bill of a patient (e.g., a parent of the patient), a patient that has received a corresponding healthcare service, a healthcare provider or corresponding agent thereof that has previously billed the payer for healthcare services, a collection agency that has taken on the responsibility of collecting past due bills from the payer for services that a patient has received, an insurer, and the like. In certain embodiments, the health transaction history provider provides data associated with the past transaction history of the payer, such as an identifier for a patient (e.g., name and/or social security number), a date of birth of the patient, an identifier of a payer (e.g., name and/or social security number), identifier for a healthcare provider that issued the past bill (e.g., name and/or social security number and/or medical practice license number), a practice type indicator of the healthcare provider that issued the past bill; a date of birth of the patient, a date of birth of the payer, an amount due for the corresponding healthcare service, a due date for payment of the amount due; an indicia of the healthcare service rendered; a reference indicator for the corresponding healthcare service, a number of past attempts made to recover the amount due, an assessment of the past transaction of the payer; a receipt date of the data, corresponding healthcare services rendered, number of past attempts to recover payment for a healthcare bill, an overall assessment of the payer's transaction history (e.g., a credit score associated with healthcare bill payment), a combination thereof, and the like. A credit bureau is a person or entity that provides data about the payer's credit score that is based on the payer's past transactions irrespective of the service provided to a patient (e.g., mortgage payment history of the payer). Examples of credit bureaus include: Fair Isaac Corporation (FICO), Equifax, a credit card company that is capable of providing credit score information, and the like. A user is a user of the system 100. Examples of a user include: a subscriber of the system 100, a non-subscriber having public access to the system 100, a healthcare provider, a payer, a patient, a collection agency, a credit bureau, a health insurance company, a bank, a landlord, an employer, and the like.

As depicted in FIG. 1, one or more computing devices 102, one or more computing devices 108, one or more computing devices 110, and/or one or more computing devices 140 are part of the system 100. Consequently, any number of entities, corresponding devices, and communication fabrics are part of the system 100, and further, fewer or more entities and corresponding computing devices than those depicted in FIG. 1 are also contemplated. For example, in certain embodiments, a first healthcare provider is both a first user and a first health transaction history provider such that the corresponding first History Provider Computing Device 102 is the same computing device as the User Computing Device 108 of the first healthcare provider. In another example, a payer is both a second user and a second health transaction history provider such that the corresponding second History Provider Computing Device 102 is the same computing device as the second User Computing Device 108 of the payer. In yet another example, a first set of healthcare providers have their respective History Provider

Computing Devices 102 and a second set of healthcare providers have their respective User Computing Devices 108. In certain embodiments, the first set of healthcare providers is the same as the second set of healthcare providers; in another embodiment, the first set of healthcare providers is different from the second set of healthcare providers such that one or more healthcare providers are different among the first and second sets. Other variations of entities and corresponding computing devices are also contemplated.

In certain embodiments, one or more computing devices 102, one or more computing devices 108, one or more computing devices 110, and one or more computing devices 140 are each an article of manufacture. Examples of an article of manufacture include: a server, a mainframe computer, a mobile telephone, a multimedia-enabled smartphone, a tablet computer, a personal digital assistant, a personal computer, a laptop, a set-top box, an MP3 player, an email enabled device, a web enabled device, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods. Each article of manufacture (computing device 102, 108, 110, and 140) includes a non-transitory computer readable medium having a series of instructions, such as computer readable program steps encoded therein. In certain embodiments, the non-transitory computer readable medium includes one or more data repositories.

By way of illustration and not limitation, FIG. 1 illustrates the computing device 110, the computing device 102, the computing device 108, and the computing device 140 as each including: an input/output means (111, 121, 131, and 141, respectively) such as a keyboard, a mouse, a stylus, touch screen, a camera, a scanner, or a printer; a processor (112, 122, 132, and 142, respectively); a non-transitory computer readable medium (113, 123, 133, and 143, respectively) having a series of instructions, such as computer readable program steps encoded therein. The non-transitory computer readable mediums 113, 123, 133, and 143 each include corresponding computer readable program code (114, 124, 134, and 144, respectively) and one or more data repositories (115, 125, 135, and 145, respectively). The processors 112, 122, 132, and 142 access the computer readable program codes (e.g., 114, 124, 134, and 144, respectively), encoded on the corresponding non-transitory computer readable mediums (113, 123, 133, and 143, respectively), and execute one or more corresponding instructions (116, 126, 136, and 146, respectively). Other hardware and software components and structures are also contemplated. In certain embodiments, computing devices 102, 108, 110, and 140 employ hardware and/or software that support accelerometers, gyroscopes, magnetometers (e.g., solid state compasses) and the like.

In certain embodiments, one or more portions of the system 100 are implemented as a web-based software application. Although not shown, in some embodiments, at least one or more portions of the system 100 is implemented as a software and/or hardware module that can be locally executed on one or more of the computing devices. In such instances, other functionalities of the system 100 can be accessed via the communication fabrics 104, 106, and/or 109. For example, a software application locally installed at the User Computing Device 108 can be used to access at least a portion of the system 100.

In certain embodiments, the system 100 includes a hardware-based module (e.g., a digital signal processor (DSP), a field programmable gate array (FPGA)) and/or a software-based module (e.g., a module of computer code, a set of processor-readable instructions that are executed at a processor). In some embodiments, one or more of the functions associated with the system 100 is performed, for example, by different modules and/or combined into one or more modules locally executable on one or more computing devices 102, 108, 110, and/or 140.

In certain embodiments, the processors 122, 132, and 142 access corresponding Application Program Interfaces (APIs) encoded on the corresponding non-transitory computer readable mediums (123, 133, and 143, respectively), and execute instructions (e.g., 126, 136, and 146, respectively) to electronically communicate with computing device 110, for example. Similarly, the processor 110 accesses the computer readable program code 114, encoded on the non-transitory computer readable medium 113, and executes an instruction to electronically communicate with the computing device 102, 108, and/or 140 via the respective communication fabric (e.g., 104 and/or 106). In certain embodiments, the computing device 110 provides access to the computing devices 102, 108, and 140 to execute the computer readable program code 116 via a Software as a Service (SaaS) means.

In certain embodiments, the data repositories 115, 125, 135, and 145 each comprises one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, . . . etc. In certain embodiments, one or more of the data repositories 115, 125, 135, and 145 are structured by a database model, such as a relational model, a hierarchical model, a network model, an entity-relationship model, an object-oriented model, a combination thereof, or the like. For example, in certain embodiments, the data repository 115 is structured in a relational model that stores data regarding a payer.

In certain embodiments data is received from one or more computing devices 102, 108, 110, and 140 and stored on the “Cloud” such as a data storage library. One or more of the data repositories 125, 135, 115, and 145 have corresponding physical storage devices. In certain embodiments, data storage libraries are configured in a Peer To Peer Remote Copy (“PPRC”) storage system, wherein the data in a first data storage library (e.g., a storage library at data repository 125) is automatically backed up in a second data storage library (e.g., a storage library at data repository 115). In certain embodiments, Applicant's PPRC storage system utilizes synchronous copying. In certain embodiments, Applicant's PPRC storage system utilizes asynchronous copying.

In certain embodiments, the computing devices 102, 108, 110, and 140 include wired and/or wireless communication devices which can employ various communication protocols including near field (e.g., “Blue Tooth”) and/or far field communication capabilities (e.g., satellite communication or communication to cell sites of a cellular network) that support any number of services such as: telephony, Short Message Service (SMS) for text messaging, Multimedia Messaging Service (MMS) for transfer of photographs and videos, electronic mail (email) access, or Global Positioning System (GPS) service, for example. A corresponding log (e.g., 117, 127, 137, and 147) is maintained of the data communicated and/or information about the data communicated (e.g., date and time of transmission, frequency of transmission . . . etc.) between any or all of the computing devices 102, 108, 110, and 140. In certain embodiments, the log (e.g., 117, 127, 137, and 147) is analyzed and/or mined by one or more computing devices of the system 100 (e.g., computing device 102, 108, 110, and 140).

In certain embodiments, the communication fabrics 104, 106, and/or 109 (shown with an arrow for simplicity) comprise the Internet, an intranet, an extranet, a storage area network (SAN), a wide area network (WAN), a local area network (LAN), a virtual private network, a satellite communications network an interactive television network, any combination of the foregoing, and the like. In certain embodiments, the communication fabrics 104, 106, and/or 109 contain either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 104, 106, and/or 109 utilize any of a variety of communication protocols, such as Transmission Control Protocol/Internet Protocol (TCP/IP), for example. In certain embodiments, the communication fabrics 104, 106, and/or 109 comprise one or more switches (e.g., 105 and 107).

In certain embodiments, Applicant's computer readable program code 114 is encoded in a non-transitory computer readable medium 113 of the computing device 110. In certain embodiments, processor 112 executes Applicants' computer readable program code 114 to allow a History Provider Computer Device 102 and/or a Bureau Computing Device 102 to upload or transmit data associated with the transaction history (e.g., payment or non-payment of) of a payer to the computing device 110. The computing device 110 uses a predetermined rule and the received data to determine a risk level of the payer paying a future bill. In certain embodiments, the risk level is directed to healthcare services; in certain embodiments, the risk level is specific to an identified healthcare service, such as an healthcare service rendered by a surgeon or an initial consult of a general practice doctor or a healthcare service with an identified code such as ICD-9 codes of International Statistical Classification of Diseases and Related Health Problems. Health transaction history provider and/or Users implement Applicant's computer readable program code (134 and 144, respectively) on a corresponding computing device (108 and 140, respectively) to publically and/or through an exclusive membership, provide or access the transaction history data and/or receive an indicium of the risk level. The user, in turn, determines whether to admit the patient whose bill the payer is to pay.

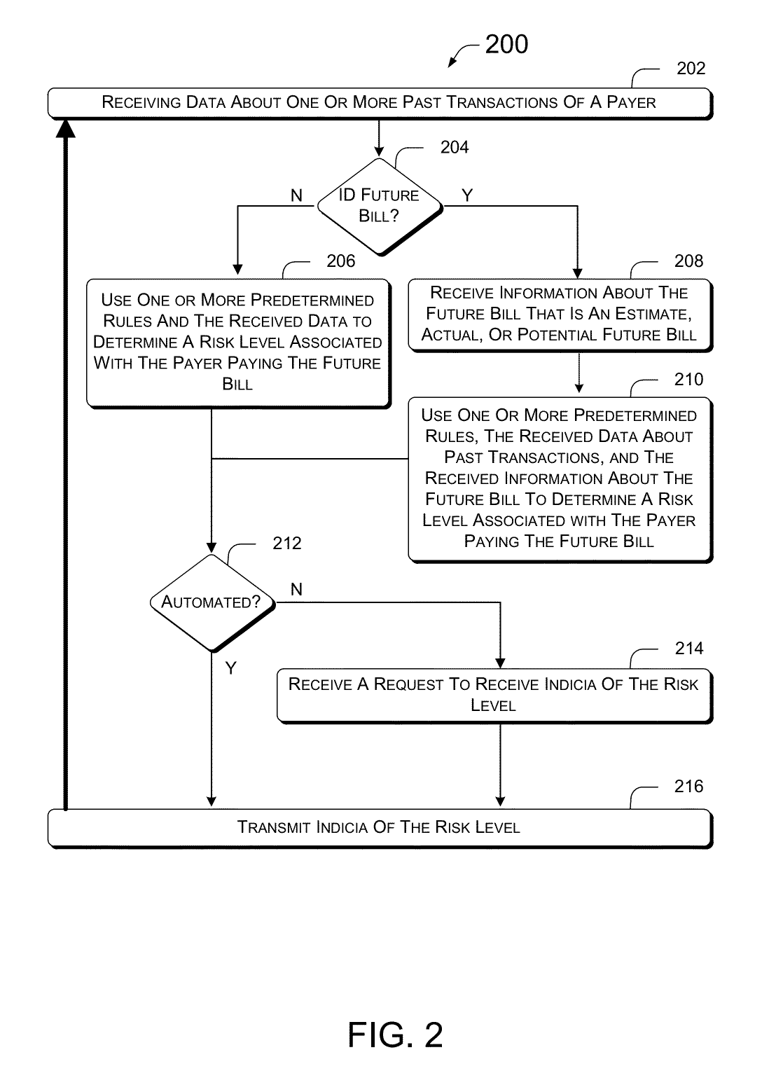

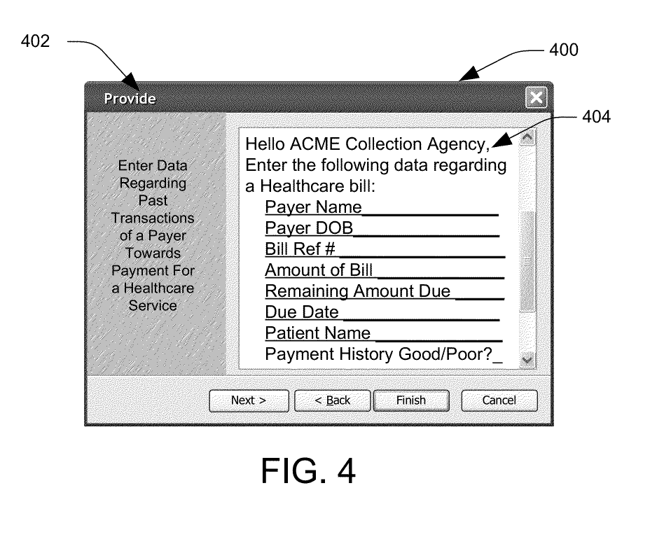

Referring to FIG. 2, a flow chart illustrates a method 200 for analyzing a transaction history of a payer. At step 202 data about one or more past transactions of a payer is received. For example, a History Provider Computing Device 102 and/or a Bureau Computing Device 140 transmits, via the first communication fabric 104, to the Host Computing Device 110, an identifier of a corresponding payer, a corresponding amount due on a bill for one or more healthcare services, a date that each amount was due, and/or past full or partial payments of corresponding bills. The Host Computing Device 110, in turn, stores the received data at the data repository 115 in association with each payer. Referring to FIG. 4, an exemplary user interface 400 is rendered on a display (e.g., input/output means 121) of a History Provider Computing Device 102 of ACME

Collection Agency. Here, ACME Collection Agency is prompted to provide 402 to the Host Computing Device 110 the data regarding the transaction history 404 of the payer, such as the payer's: name, date of birth, bill reference number, amount of bill, remaining amount due, due date, patient name, and an indication if the payment history of the payer is “Good” or “Poor.” As previously stated, other data is also contemplated. For example, ACME Collection Agency provides an ICD 9 code for the corresponding healthcare service rendered, an identifier for the healthcare provider that rendered the healthcare service, an indicator of the type of practice of the healthcare provider (e.g., “surgeon”), and/or the diagnosis of the healthcare provider at user interface 400.

Referring back to FIG. 2, at step 204, a determination is made whether a future bill is identified. If a future bill is not identified, method 200 moves from step 204 to step 206 to determine a risk level irrespective of a future bill. At step 206, a future bill is not identified and the risk level is determined based on, at least, the data received at step 202 and one or more predetermined rules, such as a predetermined algorithm or model. Alternatively, if a future bill is identified, method 200 moves from step 204 to step 208 to determine a risk level based in part on the identified future bill.

In certain embodiments, the predetermined rule is a mathematical algorithm that is usable to analyze and/or categorizes the received data or a derivative of the received data (e.g., an average or other mathematical derivative). For example, a first predetermined rule uses a weighted average of an amount due to determine a risk level, such as the following predetermined rule:

Score=(for i=1 to N Σ (Amount Due*Months Overdue))/N, where “N” is the number of past bills and “i” increments from the first to the Nth past bill. To illustrate, if the received data of step 202 indicates that a payer has: a first past bill of $10,000 for a cardiovascular surgical procedure that is past due five months; and a second past bill of $100 for a tooth extraction that is past due 2 months, then Score=((10,000*5)+(100*2))/2, which equals 25,100. Other predetermined rules are also contemplated, such as a using a statistical model for evaluating the data received at step 202 to provide the risk level as a probability of payment.

In certain embodiments, a change in a pattern of payment of a payer, as denoted by the received data of step 202, is a parameter of the predetermined rule and consequently affects the risk level determined at step 206 (or step 208). For example, if a payer has consistently shown improvement in shortening overdue periods during a specified date range or making partial or full payments more often, then the predetermined rule takes this characteristic of the data received at step 202 into consideration.

In certain embodiments, the risk level includes a classification of the risk that the payer will pay a future bill. Here, the classification is determined using a predetermined criterion. For example, the predetermined criterion includes one or more thresholds for ranges of the “Score” values. To illustrate, the predetermined criterion is as follows: if a Score is between 0-500 then the risk level is classified in the classification of “low,” “green,” as having “five stars,” and the like. Alternatively, if a Score is between 501-2000, then the risk level classification is “moderate,” “yellow,” or “three stars”; and if the Score is 2001 and above, the risk level classification is “high,” “red,” or “one star.” In the above example the Score of 25,100 falls under the last range and the risk level of the payer is “high.” Other predetermined criteria are also contemplated.

When the future bill is identified, the method of 200 in FIG. 2 moves from step 204 to step 208. At step 208, information about the future bill is received. For example, a user, such as a chiropractor, uses a corresponding User Computing Device 108 of system 100 in FIG. 1 to transmit the information to the Host Computing Device 110 via the communication fabric 106. In certain embodiments, the information about the future bill is an actual bill (e.g., an amount that the payer owes the healthcare provider for services rendered but is not yet past due), an estimated bill (e.g., an estimated amount the payer will likely be charged for a known future healthcare service that the healthcare provider has diagnosed is necessary or is considering rendering to a corresponding patient), or a potential bill (e.g., potential amount typically charged for a category of a healthcare service, such as an office visit). Other types of future bills are also contemplated.

As with step 206, at step 210, one or more predetermined rules and the received data of step 202 are used to determine a risk level associated with the payer paying the future bill. In step 208, the information about the identified bill from step 208 is also used to determine the risk level. For example, in certain embodiments, the identified future bill is used to narrow the analysis of the risk level to past bills that match the future bill. To illustrate, the information about the future bill of step 208 indicates that the future bill is for an estimated amount of US$100 for an office visit at a general practice doctor's office. Here, a set is selected from the data received at step 202 for analysis at step 206. For example, the selected set includes past bills for office visits at a general practice doctor's office and/or past bills that are $100 or less, and the like. Here, the selected set of data from step 202 is used along with the predetermined rule to determine the risk level associated with paying for (a) an office visit; and/or (b) future bills of US$100 or less, for example.

Steps 206 and 210 each proceed to step 212 where a determination is made if indicium about the risk level is to be automatically reported or reported after a request is made. In certain embodiments, the indicium about the risk level includes: the level of risk determined in either steps 206 or 210, a classification of the risk level, a list of debts due by the payer, a probability indicator, a narrative (e.g., “do not admit this patient”), a combination thereof, or the like. If a determination is made at step 212 that the transmission is to be sent automatically, then step 212 moves to step 216 where the indicium of the risk level is transmitted to a recipient without prompting. For example, the Host Computing Device 110 has a preset schedule (e.g., every time there is a change in the risk level of the payer and/or every first Monday of the month . . . etc.) to transmit the indicium of the determined risk level of a payer to the User Computing Device 108 of a first healthcare provider such as by sending the risk level in a format that is usable by the healthcare provider's Electronic Medical Record System (EMRS).

Alternatively, if a determination is made at step 212 that the transmission is not to be sent automatically, then step 212 moves to step 214. At step 214, a request to receive the indicium of the risk factor is received. For example, the User Computing Device 108 of a dietician transmits a request to the Host Computing Device 110, requesting the indicium of the risk level for an identified payer. The request includes the payer's social security number. The Host Computing Device 110, in turn, matches the received social security number with a social security number stored at the data repository 115 to find a match. The matched social security is associated with the data regarding the corresponding payer received at step 202 and/or a previously determined risk level from step 210 in a profile stored at the data repository 115, for example. The risk level is then included in a reply transmission for delivery to the User Computing Device 108 of the dietician at step 216.

In certain embodiments, the steps of method 200 are combined or in a different order. For example, in certain embodiments, steps 208 and 214 are combined such that the request includes the information about the future bill. Other combinations or variations are also contemplated.

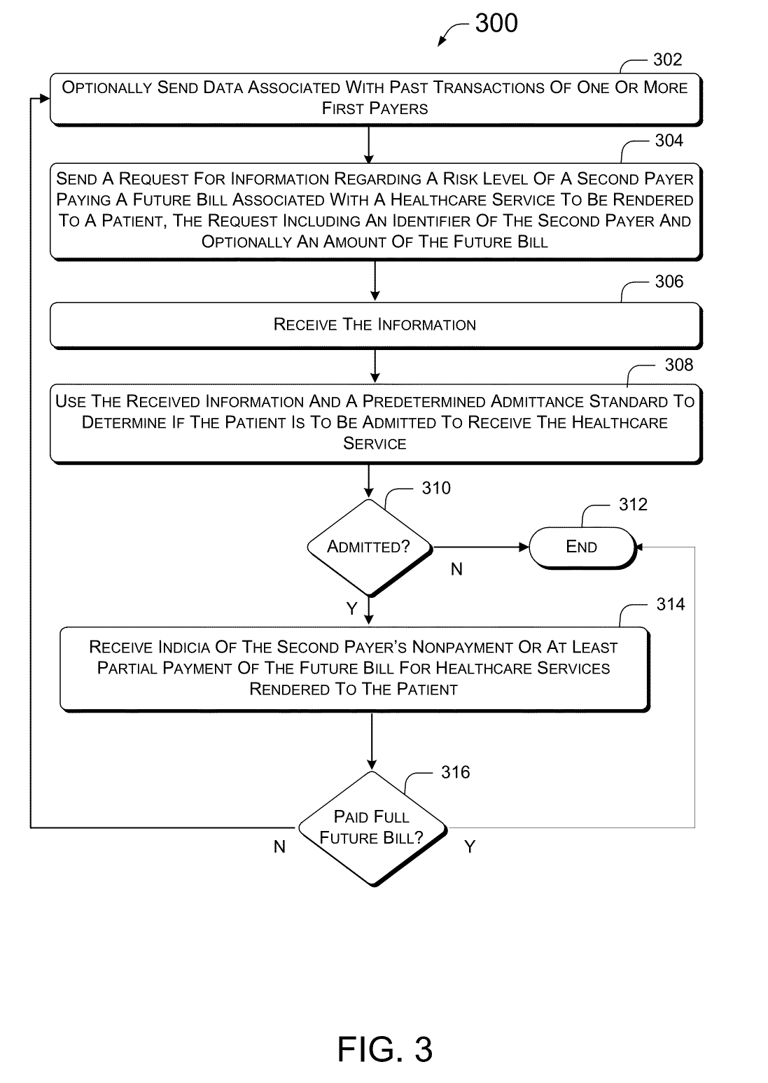

Referring to FIG. 3, a method 300 for determining whether to admit a patient using the system of FIG. 1 is illustrated. At step 302, a healthcare provider optionally uses the History Provider Computing Device 102 to send data associated with past transactions (e.g., past bills) of one or more first payers, such as sending data about the past bills of a plurality of corresponding first payers, to the Host Computing Device 110 via the communication fabric 104 that is a public network, for example. At step 304, a request for information regarding a risk level of a second payer is sent. For example, the healthcare provider is a paid subscriber having access to the system 100 as a user. Here, the healthcare provider uses the User Computing Device 108, which is the same as History Provider Computing Device 102, to send the request to the Host Computing Device 110 via the communication fabric 106, which is a private network, for example. In certain embodiments, the second payer is one of the first payers from step 302. In other embodiments, the second payer is not one of the first payers from step 302. The request in FIG. 3 includes an identifier of the second payer and optionally information about a corresponding future bill, such as an estimated amount for a proposed procedure.

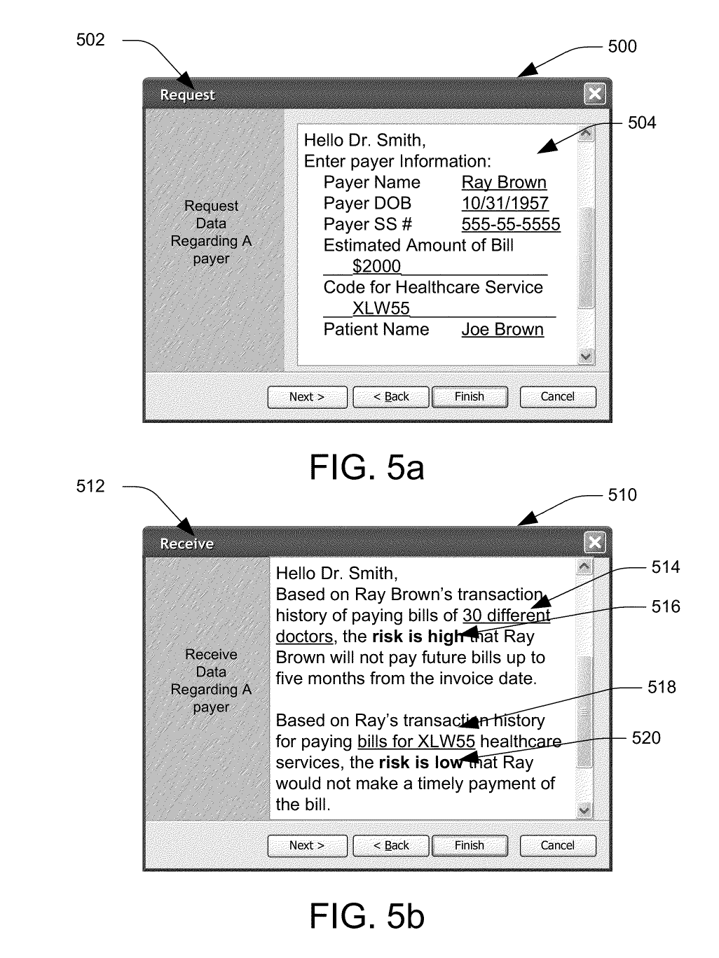

Referring to FIG. 5a, an exemplary user interface 500 that is rendered on a User Computing Device 108 is illustrated. The user interface 500 provides an interface for forming the request 502 of step 304 of method 300 (FIG. 3). Here, the user provides the name, date of birth, and social security number of the payer along with an estimated amount for the future bill, shown as US$2000. The user also provides a code for the healthcare service, shown as XLW55 and the name of the patient.

Referring to FIGS. 3 and 5b, at step 306 the requested information of step 304 is received. As shown in the example user interface 510 of FIG. 5b, the user is informed that, based on the payer's past bills with 30 different doctors 514, the risk level is high 516 that the payer will not pay the future bill up to five months from the invoice date. However, based on past bills 518 of the payer for the healthcare service associated with the code XLW55, there is a low risk level 520 that the payer will not pay the future bill in a timely manner.

At step 308, the received information of step 306 is used along with a predetermined admittance standard to determine if a respective patient is to be admitted to receive the healthcare service. An example of an admittance standard includes, a policy of a healthcare provider to admit patients whose payers have a risk level indicating an 80% likelihood of paying future bills of $2000 or less within four months of a respective invoice date. Other examples of admittance standards include: payers with a “Green” risk level, payers that have shown an improvement in paying past bills within the past year, and the like.

If a determination is made to not admit the respective patient at step 308, step 310 moves to step 316 where the respective patient is not admitted and is not rendered the corresponding healthcare service and method 300 ends at step 312. Alternatively, if a determination is made to admit the respective patient at step 308, step 310 moves to step 314 where the respective patient is admitted, is rendered the corresponding healthcare service, and the payer is sent a corresponding future bill that is an actual bill. At step 314, information indicating if the future bill is still unpaid or was at least partially paid is received. For example, the healthcare provider indicates that the payer has paid an amount of money towards the past bill into the healthcare provider's accounting system within the healthcare provider's History Provider Computing Device 102. At step 316 a determination is made whether the future bill was paid in full. If the future bill is paid in full, the method 300 ends at step 312. If the future bill is not paid in full, then method 300 optionally moves back to step 302 and method 300 is repeated.

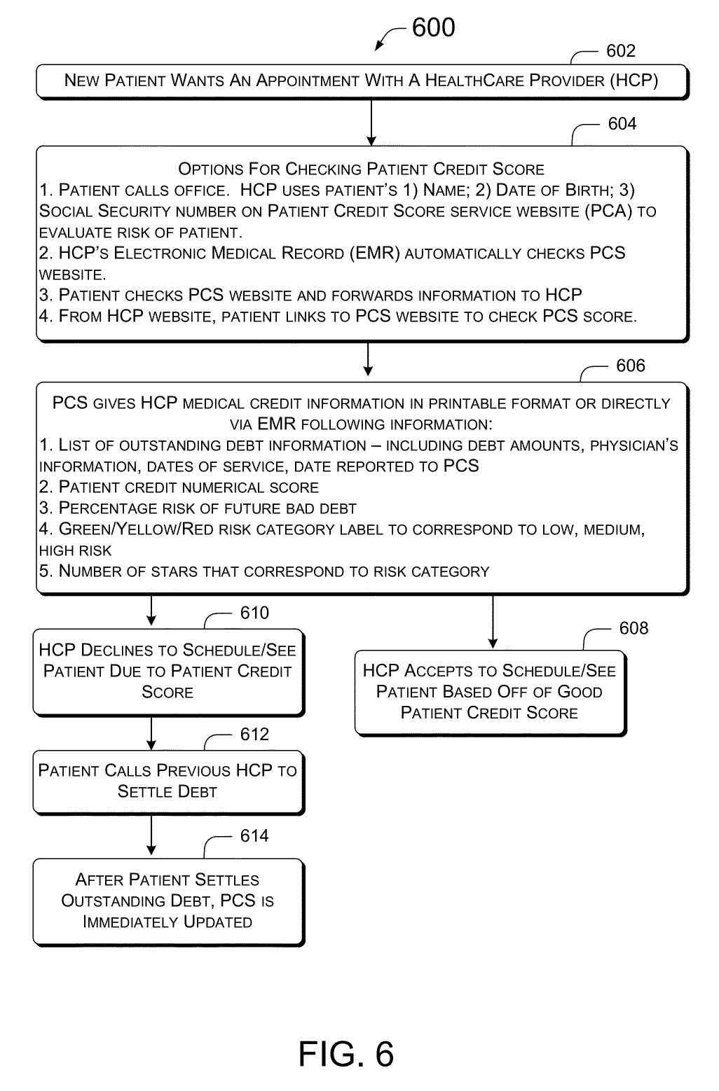

Referring to FIG. 6, another exemplary method 600 for analyzing a transaction history of a payer is illustrated. At step 602, a patient wants an appointment with a healthcare provider. At step 604, a request is made to receive an indicium of a risk level associated with a payer. For example, the patient, a healthcare provider (HCP), the Electronic Medical Record System of the HCP uses a respective User Computing Device 108 to form a transmission to the Host Computing Device 110 (denoted as PCS) requesting the indicium regarding the risk level. At step 606, the Host Computing Device 110 sends the requested indicium regarding the risk level, such as sending: a list of outstanding debt, a patient/payer credit numerical score, a percentage of risk associated with paying a future bill, or a classification of the risk level such as a color label or number of stars. If the risk level meets the healthcare provider's admittance standard, the HCP admits the patient at step 608. Alternatively, at step 610, the HCP declines to admit the patient due to the unsatisfactory risk level of the payer. The patient/payer then settles corresponding bad debt with previous HCPs at step 612. When the bad debt is settled, the respective previous healthcare provider (or respective agent/collection agency) reports the settlement to the Host Computing Device 110, which then updates the risk level analysis.

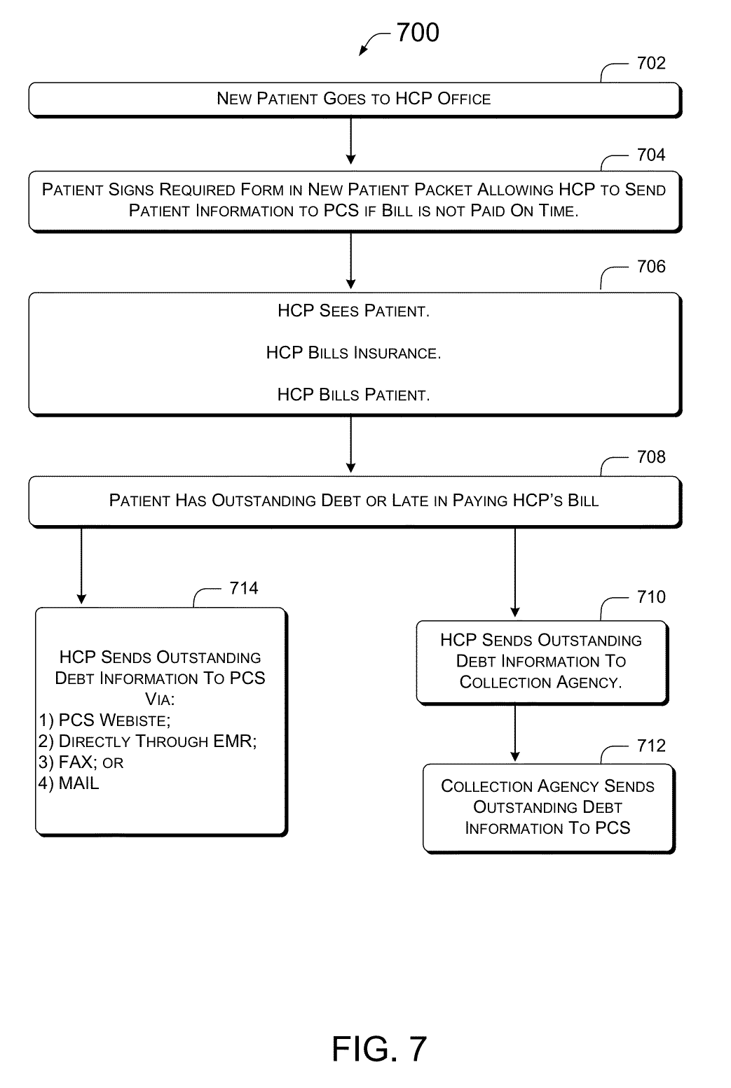

Referring to FIG. 7, another exemplary method 700 for analyzing a transaction history of a payer is illustrated. At step 702, a patient requests admittance from a healthcare provider. At step 704, the patient and/or payer signs a new patient packet that allows the HCP to send the patient's and/or payer's data to the Host Computing Device 110 if a future bill is not timely paid in full. At step 706, the HCP sees the patient and bills a corresponding insurer and/or the patient/payer. At step 708, the patient/payer defaults on paying the future bill of the HCP. The HCP then sends the data regarding the patient/payer to the Host Computing Device 110 at step 714 and/or sends the future bill to a collection agency at step 710, which in turn, sends the data to the Host Computing Device 110 at step 712.

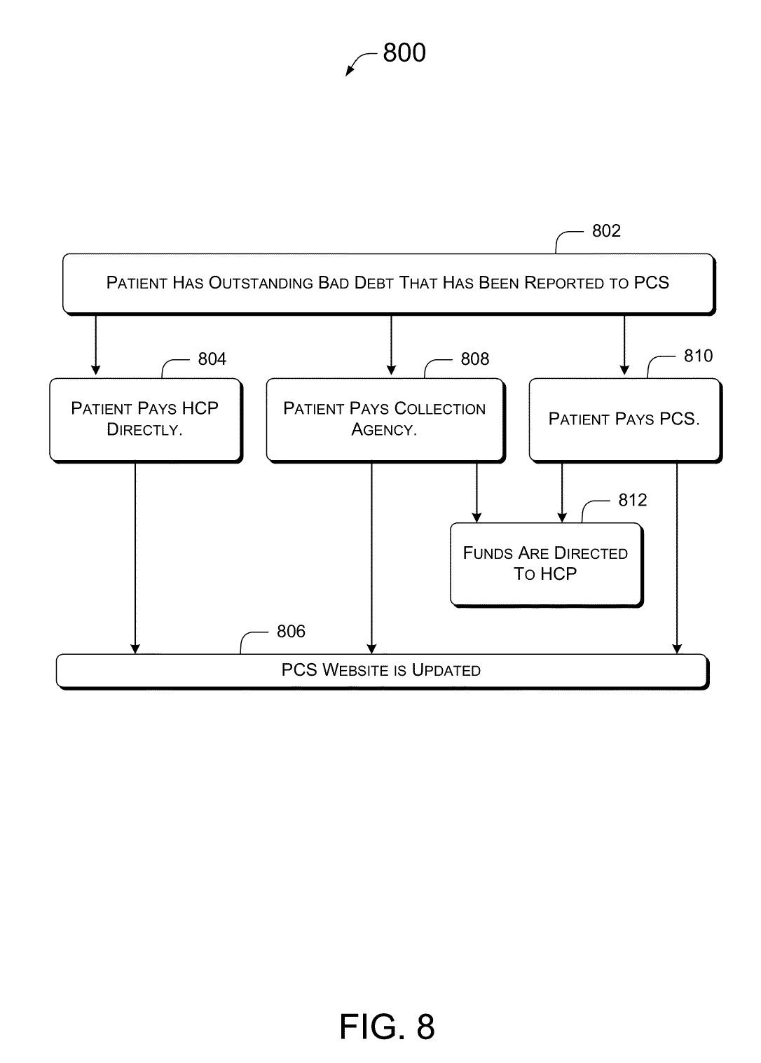

Referring to FIG. 8, another exemplary method 800 for analyzing a transaction history of a payer is illustrated. At step 802, a patient/payer has an outstanding past bill that has been reported to the Host Computing Device 110. The patient/payer then (a) pays the HCP directly at step 804, (b) pays a respective collection agency at step 808, or (c) pays the host at step 810. If the later two, the collection agency or host direct all or part of the received payment to the HCP (e.g., less commission . . . etc.) at step 812. At step 806, the data regarding the payer is then updated, such as by the collection agency sending information about the payment to the Host Computing Device 110.

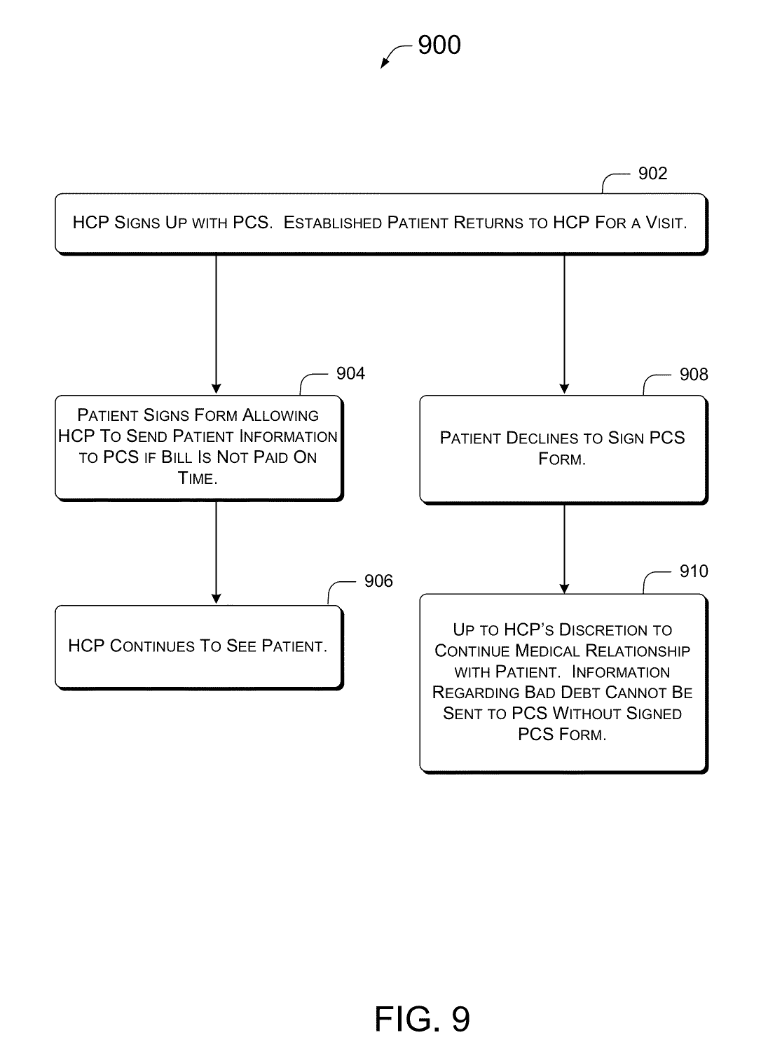

Referring to FIG. 9, another exemplary method 900 for analyzing a transaction history of a payer is illustrated. At step 902, the HCP becomes a subscriber to have access to the system 100. A past patient returns to the HCP for further healthcare services. The healthcare provider request the patient/payer to sign a waiver allowing corresponding data about the past transactions of the payer to be sent to the Host Computing Device 110 at step 904. If signed, the HCP continues to see patient/payer at step 906. However, if the patient/payer declines to sign the waiver at step 908, the HCP decides, at step 910, whether to maintain the allowed admittance of the patient/payer. In certain embodiments, the HCP does not send the data about the payer's past transaction history to the Host Computing Device 110 if the waiver is not signed.

In the above example, once the healthcare provider is using the system 100, all new patients sign an agreement acknowledging that if future bills are not paid according to each individual office's policies, the corresponding debt will be sent to a collection agency as well as reported to the Host Computing Device 110. Existing patients also sign the agreements at the next follow up visit. If the patient refuses to sign the agreement, it is up to the individual healthcare provider whether or not to continue seeing the patient. Here, bad debt will be reported to the Host Computing Device 110, via website entry for example, if the patient has signed the agreement. The waiver can be part of other documents that the patient is to sign. For example, the waiver is a part of a new patient paperwork notifying patients that outstanding debt will be sent to collections and/or that if they no show or late cancel for an appointment they will be charged US$50.

In certain embodiments, when the healthcare provider requests indicium regarding a risk level of a payer, such as by accessing a respective website of the host, the healthcare provide receives: 1) how much is owed; 2) which healthcare providers are owed the bad debt; and/or 3) dates of the bad debt. In certain embodiments, the healthcare provider is not able to see the respective diagnosis of the patient. As stated previously, patients/payers are examples of users of the system 100, and consequently are able to check their own risk level in certain embodiments. In certain embodiments, the User Computing Device 108 determines the risk level of the payer using the predetermined rule.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as a logical flow-chart diagrams (e.g., FIGS. 2, 3, and 6-9). As such, the depicted order and labeled steps are indicative of one embodiment of the presented method. In certain embodiments, other steps and methods are conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types are employed in the flow-chart diagrams, they are understood not to limit the scope of the corresponding method. Indeed, some arrows or other connectors may be used to indicate only the logical flow of the method. For instance, an arrow indicates a waiting or monitoring period of unspecified duration between enumerated steps of the depicted method. Additionally, the order in which a particular method occurs may or may not strictly adhere to the order of the corresponding steps shown.

In certain embodiments, individual steps recited in various processes are combined, eliminated, or reordered. In certain embodiments, the computer readable program code described resides in any other computer program product, where that computer readable program code is executed by a computer external to, or internal to, system 100 (FIG. 1), to perform one or more of steps recited processes described herein. In either case, the computer readable program code is encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Reference throughout this specification to “one embodiment,” “an embodiment,” “certain embodiment,” or similar language means that a particular feature, structure, or characteristic described in connection with the embodiment is included in at least one embodiment of the present invention. Thus, appearances of the phrases “in one embodiment,” “in an embodiment,” “in certain embodiments,” and similar language throughout this specification may, but do not necessarily, all refer to the same embodiment. It is noted that, as used in this description, the singular forms “a,” “an” and “the” include plural referents unless the context clearly dictates otherwise.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, multiple, distributed qualification processing systems can be configured to operate in parallel.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

I claim:

1. An article of manufacture comprising a processor and a non-transitory computer readable medium having computer readable program code encoded therein for analyzing a transaction history of a payer, the computer readable program code comprising a series of computer readable program steps to effect:
receiving data about a past transaction of a payer towards payment of a past bill; and
using a predetermined rule and the received data to determine a risk level associated with the payer paying a future bill of a first healthcare provider.

2. The article of manufacture of claim 1, wherein the future bill is selected from a group consisting of: an unidentified bill; and an identified bill.

3. The article of manufacture of claim 1, wherein receiving the data includes receiving data about a plurality of said past transactions of a plurality of corresponding said payers.

4. The article of manufacture of claim 1, wherein receiving the data includes receiving at least one of: a first identifier for a patient associated with the past bill; a date of birth of the patient; a second identifier for the payer; a date of birth of the payer; a third identifier for a second healthcare provider that issued the past bill; a practice type indicator of the second healthcare provider; an amount due for the past bill; a due date for payment of the amount due; an indicium of the healthcare service rendered in association with the past bill; a reference indicator for the healthcare service; a number of past attempts made to recover the amount due; an assessment of the past transaction of the payer; a receipt date of the data; and a combination thereof.

5. The article of manufacture of claim 1, wherein:
a second healthcare provider issued the past bill;
the first and second said healthcare providers are different from each other; and
the computer readable program code further comprises a series of computer readable program steps to effect forming a transmission for delivery to the first healthcare provider, the transmission including a classification of the risk level.

6. The article of manufacture of claim 1, wherein the computer readable program code further comprises a series of computer readable program steps to effect:
receiving further said data including an amount of money paid by the payer towards payment of the past bill; and
using the further said data to determine a second said risk level.

7. The article of manufacture of claim 6, wherein the computer readable program code further comprises a series of computer readable program steps to effect forming a transmission for delivery to a first healthcare provider, the transmission including an indicium of the second said risk level.

8. A computer program product encoded in a non-transitory computer readable medium, the computer program product being useable with a computing device comprising a programmable processor to provide an analysis of a transaction history of a payer, the computer program product comprising:
computer readable program code that causes the programmable processor to receive data about a past transaction of a payer towards payment of a past bill for a first healthcare service rendered to a first patient by a first healthcare provider; and
computer readable program code that causes the programmable processor to use a predetermined rule and the received data to determine a risk level associated with the payer paying a future bill.

9. The computer program product of claim 8, further comprising computer readable program code that causes the programmable processor to form a transmission for delivery to a second healthcare provider, the transmission including indicium of the risk level, wherein the second healthcare provider is different from the first healthcare provider.

10. The computer program product of claim 8, further comprising:
computer readable program code that causes the programmable processor to receive a transmission from a second healthcare provider including an estimated amount for the future bill;
computer readable program code that causes the programmable processor to use the predetermined rule, the received data, and the estimated amount to determine a second risk level associated with the payer paying the future bill; and
computer readable program code that causes the programmable processor to form a transmission for delivery to the second healthcare provider, the transmission including indicia of the second risk level.

11. The computer program product of claim 8, further comprising:
computer readable program code that causes the programmable processor to receive further said data including an amount of money paid by the payer towards payment of the past bill; and
computer readable program code that causes the programmable processor to use the further said data to determine a second said risk level.

12. The computer program product of claim 11, further comprising computer readable program code that causes the programmable processor to form a transmission for delivery to a second healthcare provider, the transmission including an indicium of the second said risk level.

13. The computer program product of claim 8, wherein receiving the data about the past transaction includes receiving at least one of: a first identifier for a patient associated with the past bill; a date of birth of the patient; a second identifier for the payer; a date of birth of the payer; a third identifier for a second healthcare provider that issued the past bill; a practice type indicator of the second healthcare provider; an amount due for the past bill; a due date for payment of the amount due; an indicium of the healthcare service rendered in association with the past bill; a reference indicator for the healthcare service;
a number of past attempts made to recover the amount due; an assessment of the past transaction of the payer; a receipt date of the data; and a combination thereof

14. The computer program product of claim 8, wherein the predetermined rule is a predetermined algorithm based on a statistical model.

15. A method for patient admittance, the method comprising:
forming, at a computing device, a transmission including a request to receive information regarding a risk level of a payer paying a future bill of a patient, wherein the risk level is based on a transaction history of the payer towards payment of a plurality of past bills associated with corresponding first healthcare services;
receiving, at the computing device, the information; and
using, at the computing device, the received information and a predetermined admittance standard to determine if the patient is to receive a second healthcare service.

16. The method of claim 15, further comprising, if the patient is admitted, forming, at the computing device, a transmission including an amount paid by the payer towards a future bill that was subsequently rendered to the patient.

17. The method of claim 15, wherein the second healthcare service is to be rendered by a second healthcare provider that is different from at least one of the first healthcare providers that rendered the corresponding first healthcare services.

18. The method of claim 15, further comprising, at the computing device, if a determination is made not to render the patient the second healthcare service, not allowing admittance of the patient at the computing device.

19. The method of claim 15, wherein the risk level is further based the payer has consistently shown improvement in shortening overdue periods for the past bills over a specified date range.

20. The method of claim 15, further comprising forming, at a computing device, a second transmission including data about an identified bill of a second healthcare provider this is to render the second healthcare service, wherein the risk level is also based on the data about the identified bill.
